(19) United States
(12) Patent Application Publication
(10) Pub. No.: US 2026/0261761 A1
(43) Pub. Date: Sep. 3, 2026

(54) PHASE DIFFERENCE MAP GENERATION APPARATUS, PHASE DIFFERENCE MAP GENERATION METHOD, IMAGE DATA ACQUISITION APPARATUS, FOCUSING CONTROL METHOD, LEARNING METHOD, AND PHASE DIFFERENCE MAP GENERATOR

(71) Applicant: FUJIFILM Corporation, Tokyo (JP)

(72) Inventor: Ryosuke NAGAMI, Saitama-shi (JP)

(73) Assignee: FUJIFILM Corporation, Tokyo (JP)

(21) Appl. No.: 19/654,540

(22) Filed: Apr. 22, 2026

Related U.S. Application Data
(63) Continuation of application No. PCT/JP2024/035602, filed on Oct. 4, 2024.

(30) Foreign Application Priority Data
Oct. 25, 2023 (JP) 2023-183553

(51) Int. Cl. H04N 23/67; H04N 25/40; H04N 25/704

(52) U.S. Cl. CPC H04N 23/672; H04N 23/675; H04N 25/40; H04N 25/704

(57) ABSTRACT

A phase difference map generation apparatus according to one aspect of the present invention includes a processor, in which the processor is configured to acquire, from an image data acquisition unit including a single optical system and an imaging element having a phase difference pixel, at least first phase difference image data and second phase difference image data, perform pre-processing on the first phase difference image data and the second phase difference image data to acquire first correction image data and second correction image data, and generate, from the first correction image data and the second correction image data, a phase difference map in which a phase difference amount and a direction of a phase shift between the first phase difference image data and the second phase difference image data are mapped, and the pre-processing is processing based on characteristics of processing for generating the phase difference map.

### CROSS-REFERENCE TO RELATED APPLICATIONS

The present application is a Continuation of PCT International Application No. PCT/JP2024/035602 filed on Oct. 4, 2024, claiming priority under 35 U.S.C § 119(a) to Japanese Patent Application No. 2023-183553 filed on Oct. 25, 2023. Each of the above applications is hereby expressly incorporated by reference, in its entirety, into the present application.

### BACKGROUND OF THE INVENTION

### 1. Field of the Invention

The present invention relates to a phase difference map generation apparatus, a phase difference map generation method, an image data acquisition apparatus, a focusing control method, a learning method, and a phase difference map generator, and particularly relates to a technique of handling phase difference image data.

### 2. Description of the Related Art

Regarding a technique of handling image data, for example, JP2022-019374A discloses a technique of estimating distance information from defocus blurriness of a captured image.

### SUMMARY OF THE INVENTION

One embodiment according to the disclosed technology provides a phase difference map generation apparatus, a phase difference map generation method, an image data acquisition apparatus, a focusing control method, a learning method, and a phase difference map generator.

A phase difference map generation apparatus according to a first aspect of the present invention comprises a processor, in which the processor is configured to acquire, from an image data acquisition unit including a single optical system and an imaging element having a phase difference pixel, at least first phase difference image data and second phase difference image data, perform pre-processing on the first phase difference image data and the second phase difference image data to acquire first correction image data and second correction image data, and generate, from the first correction image data and the second correction image data, a phase difference map in which a phase difference amount and a direction of a phase shift between the first phase difference image data and the second phase difference image data are mapped, and the pre-processing is processing based on characteristics of processing for generating the phase difference map.

In the first aspect, the “phase difference image data” and the “correction image data” are two-dimensionally distributed data and can be handled in the same manner as a normal image. Although these image data are not intended for display or viewing as an image, the image data may be subjected to necessary processing and displayed in the same manner as a normal image for viewing by a user. In addition, the “single optical system” is, for example, a monocular optical system, and the “image data acquisition unit” can be configured in the same manner as a normal optical system.

In the first aspect and each of the following aspects, three or more types of phase difference image data may be acquired, and a phase difference map may be generated from the three or more types of phase difference image data.

The phase difference map generation apparatus according to the first aspect may be implemented as an apparatus that acquires phase difference image data or the like from an external apparatus to generate a phase difference map, or may be realized as a processor portion of an image data acquisition apparatus or an imaging apparatus including an image data acquisition unit.

According to a second aspect of the present invention, in the phase difference map generation apparatus according to the first aspect, the pre-processing is processing for reducing a difference between image quality of the first phase difference image data and image quality of the second phase difference image data.

According to a third aspect, in the phase difference map generation apparatus according to the first or second aspect, the processor is configured to acquire image data generated from a signal output by the phase difference pixel in which one side of a light receiving section is shielded, as the first phase difference image data, and acquire image data generated from a signal output by the phase difference pixel in which the other side of the light receiving section is shielded, as the second phase difference image data.

According to a fourth aspect, in the phase difference map generation apparatus according to any one of the first to third aspects, in the pre-processing, the processor is configured to perform different processing on the first phase difference image data and the second phase difference image data.

According to a fifth aspect, in the phase difference map generation apparatus according to the fourth aspect, in which, in the pre-processing, the processor is configured to perform different processing on the first phase difference image data and the second phase difference image data in at least one of content or degree.

According to a sixth aspect, in the phase difference map generation apparatus according to the third aspect, the processor is configured to perform processing for eliminating unevenness within an angle of view of the image data caused by a light shielding method, as the pre-processing.

According to a seventh aspect, in the phase difference map generation apparatus according to any one of the first to sixth aspects, the processor is configured to acquire data acquisition conditions of the first phase difference image data and the second phase difference image data, and perform the pre-processing according to the data acquisition conditions. In the seventh aspect and each of the following aspects, the “data acquisition condition” is a condition corresponding to an imaging condition in a case of capturing a normal image.

According to an eighth aspect, in the phase difference map generation apparatus according to the seventh aspect, in the pre-processing, the processor is configured to enlarge a size of an image indicated by the first phase difference image data and a size of an image indicated by the second phase difference image data according to the data acquisition conditions, and generate the first correction image data and the second correction image data from the enlarged first phase difference image data and the enlarged second phase difference image data.

According to a ninth aspect, in the phase difference map generation apparatus according to any one of the first to eighth aspects, the processor is configured to perform the pre-processing for at least one of resolution, noise, gradation, or an image structure. The ninth aspect specifically defines the content of the pre-processing.

According to a tenth aspect, in the phase difference map generation apparatus according to any one of the first to ninth aspects, the processor is configured to extract correspondence points between the first correction image data and the second correction image data, the correspondence points being the same positions of the same objects in a real space, and generate the phase difference map by mapping a phase difference amount and a direction of a phase shift for the correspondence points.

According to an eleventh aspect, in the phase difference map generation apparatus according to the tenth aspect, the processor is configured to extract a first feature point that is a feature point of the first correction image data and a second feature point that is a feature point of the second correction image data, extract the correspondence points from the first feature point and the second feature point, and generate the phase difference map by mapping a phase difference amount and a direction of a phase shift for the correspondence points.

According to a twelfth aspect, in the phase difference map generation apparatus according to any one of the first to eleventh aspects, the processor is configured to generate the phase difference map by using a phase difference map generator constructed by machine learning.

According to a thirteenth aspect, in the phase difference map generation apparatus according to the twelfth aspect, the phase difference map generator is a trained model constructed by training a neural network by providing the first phase difference image data and the second phase difference image data, and distance information corresponding to the first phase difference image data and the second phase difference image data as learning data. In the thirteenth aspect, the distance information may be ground-truth data in a case of learning, and may be a distance itself or other information corresponding to the distance.

According to a fourteenth aspect, in the phase difference map generation apparatus according to the thirteenth aspect, the phase difference map generator is constructed by training using the first phase difference image data and the second phase difference image data acquired in a state in which at least one data acquisition condition is the same.

In a case in which the number of data acquisition conditions assumed in the learning increases, it is possible to generate a phase difference map with high accuracy, but on the other hand, a learning cost (preparation of learning data or ground-truth data, learning time, and the like) increases. From such a viewpoint, in the fourteenth aspect, the learning cost is suppressed by using the first phase difference image data and the second phase difference image data acquired in a state in which at least one data acquisition condition is the same for the learning. The first phase difference image data and the second phase difference image data acquired in a state in which all data acquisition conditions are the same may be used for the learning. It is preferable to determine “to what extent the data acquisition conditions are set to be the same (to what extent the data acquisition conditions are aligned)” in consideration of the generation accuracy of the phase difference map and the learning cost.

According to a fifteenth aspect, in the phase difference map generation apparatus according to the fourteenth aspect, in a data acquisition condition of the first phase difference image data and a data acquisition condition of the second phase difference image data, at least one of a focal length of the optical system, an F number of the optical system, a shutter speed, or a focusing distance is the same.

According to a sixteenth aspect, in the phase difference map generation apparatus according to any one of the first to fifteenth aspects, the processor is configured to determine a focusing position according to data acquisition conditions of the first phase difference image data and the second phase difference image data by using the phase difference map.

According to a seventeenth aspect, in the phase difference map generation apparatus according to the sixteenth aspect, the processor is configured to determine the focusing position based on a distribution of phase difference amounts in a focusing region set in the phase difference map.

Apparatus according to an eighteenth aspect, in the phase difference map generation apparatus according to any one of the first to seventeenth aspects, the processor is configured to generate distance image data composed of the distance information by converting the phase difference amount of the phase difference map into the distance information in an optical axis direction. In the eighteenth aspect and the following aspects, the “distance image data” is data in which the distance information is two-dimensionally distributed, and can be handled in the same manner as a normal image similarly to the “phase difference image data” and the “correction image data” described above. The distance image data is not intended for display or viewing as an image, but may be displayed in the same manner as a normal image or after necessary processing, and may be viewed by a user.

According to a nineteenth aspect, in the phase difference map generation apparatus according to the eighteenth aspect, as the distance image data, the processor is configured to generate at least one of a defocus map in which the phase difference amount is converted into a defocus amount as the distance information or a distance map in which the defocus amount is converted into a subject distance as the distance information.

According to a twentieth aspect, in the phase difference map generation apparatus according to the nineteenth aspect, the processor is configured to generate the distance image data by performing post-processing on the phase difference map according to data acquisition conditions of the first phase difference image data and the second phase difference image data.

According to a twenty-first aspect, in the phase difference map generation apparatus according to the twentieth aspect, in the post-processing, the processor is configured to perform the post-processing by considering, as the data acquisition condition, at least one of ray angle information of the first phase difference image data and the second phase difference image data, position information of a focus lens included in the optical system used for acquiring the first phase difference image data and the second phase difference image data, or optical characteristics of the optical system.

An image data acquisition apparatus according to a twenty-second aspect comprises the phase difference map generation apparatus according to the sixteenth or seventeenth aspect; the image data acquisition unit; and a drive unit that drives the single optical system, in which the processor is configured to perform focusing control of driving the single optical system to the focusing position by the drive unit.

According to a twenty-third aspect, in the image data acquisition apparatus according to the twenty-second aspect, the imaging element includes a color pixel in which any one of a plurality of optical filters that transmit light having wavelength ranges that are at least partially different is disposed.

A phase difference map generation method according to a twenty-fourth aspect is a phase difference map generation method executed by a phase difference map generation apparatus comprising a processor, the method including: by the processor, acquiring, from an image data acquisition unit including a single optical system and an imaging element having a phase difference pixel, at least first phase difference image data and second phase difference image data, performing pre-processing on the first phase difference image data and the second phase difference image data to acquire first correction image data and second correction image data; and generating, from the first correction image data and the second correction image data, a phase difference map in which a phase difference amount and a direction of a phase shift between the first phase difference image data and the second phase difference image data are mapped, in which the pre-processing is processing based on characteristics of processing for generating the phase difference map.

The phase difference map generation method according to the twenty-fourth aspect may include a configuration corresponding to the phase difference map generation apparatus according to the second to twenty-first aspects. In addition, a phase difference map generation program causing a computer to execute the phase difference map generation method according to these aspects, and a non-transitory and tangible recording medium on which a computer-readable code of the phase difference map generation program is recorded can also be mentioned as aspects of the present invention.

A focusing control method according to a twenty-fifth aspect is a focusing control method executed by an image data acquisition apparatus comprising a processor, an image data acquisition unit that includes a single optical system and an imaging element having a phase difference pixel and that acquires first phase difference image data and second phase difference image data of a subject, and a drive unit that drives the image data acquisition unit, the focusing control method including: by the processor, acquiring the first phase difference image data and the second phase difference image data of the subject by the image data acquisition unit; performing pre-processing on the first phase difference image data and the second phase difference image data to acquire first correction image data and second correction image data; generating, from the first correction image data and the second correction image data, a phase difference map in which a phase difference amount and a direction of a phase shift between the first phase difference image data and the second phase difference image data are mapped; determining a focusing position according to data acquisition conditions of the first phase difference image data and the second phase difference image data by using the phase difference map; and performing focusing control of driving the single optical system to the focusing position by the drive unit, in which the pre-processing is processing based on characteristics of processing for generating the phase difference map.

A focusing control program causing a computer to execute the focusing control method according to the twenty-fifth aspect, and a non-transitory and tangible recording medium on which a computer-readable code of the focusing control program is recorded can also be mentioned as the aspects of the present invention.

A learning method according to a twenty-sixth aspect comprises: training a neural network by providing, as learning data, first phase difference image data and second phase difference image data of a subject acquired by an image data acquisition unit including a single optical system and an imaging element having a phase difference pixel, and distance information corresponding to the first phase difference image data and the second phase difference image data; and constructing, by the training, a phase difference map generator that outputs, in a case where the first phase difference image data and the second phase difference image data are input, a phase difference map in which a phase difference amount and a direction of phase shift between the first phase difference image data and the second phase difference image data are mapped. The phase difference map generator constructed by the learning method according to the twenty-sixth aspect is a trained model.

A learning method according to a twenty-seventh aspect is the learning method according to the twenty-sixth aspect, in which information based on a result of actually measuring a distance from an image data acquisition apparatus that acquires the first phase difference image data and the second phase difference image data to the subject is provided as the distance information. In the twenty-seventh aspect, the information provided may be the distance itself or other information corresponding to the distance.

A phase difference map generator according to a twenty-eighth aspect is the phase difference map generator constructed by the learning method according to the twenty-sixth or twenty-seventh aspect. The phase difference map generator according to the twenty-eighth aspect is a trained model.

### BRIEF DESCRIPTION OF THE DRAWINGS

FIG. 1 is a diagram showing a configuration of an imaging apparatus according to a first embodiment.

FIG. 2 is a diagram showing a configuration of an image processing unit.

FIGS. 3A and 3B are diagrams showing an example of pixel arrangement in an imaging element.

FIGS. 4A and 4B are diagrams showing a configuration example of each pixel.

FIG. 5 is a diagram showing an example in which phase difference pixels are two-dimensionally arranged.

FIG. 6 is a diagram showing an example in which all pixels of the imaging element are phase difference pixels.

FIG. 7 is a diagram showing a relationship between a phase difference amount and focus deviation.

FIG. 8 is a diagram showing a state of focusing control based on a phase difference image.

FIGS. 9A to 9C are diagrams showing an influence of focus deviation on a color image and phase difference pixels.

FIG. 10 is a diagram conceptually showing a state of phase difference map generation.

FIG. 11 is a diagram showing an example of a phase difference image before performing pre-processing.

FIG. 12 is a diagram showing an example of a phase difference image in a state in which the pre-processing is performed.

FIGS. 13A to 13B are diagrams showing an example of a layer configuration of a convolutional neural network (CNN).

FIG. 14 is a diagram showing a state of convolution by a filter.

FIG. 15 is a diagram showing a state of calculating a phase difference from a phase difference image after the pre-processing.

FIG. 16 is a diagram showing an example of a phase difference map for a single subject (point light source).

FIG. 17 is a diagram showing a configuration of an image processing unit in an imaging apparatus according to a second embodiment.

FIG. 18 is a diagram showing a state of generating distance image data from a phase difference map in the second embodiment.

FIGS. 19A to 19B are diagrams showing a state of post-processing in the second embodiment.

FIG. 20 is a diagram showing an example of distance image data.

### DESCRIPTION OF THE PREFERRED EMBODIMENTS

### Distance Estimation and Generation of Phase Difference Map Using Monocular Phase Difference Image

In recent years, a distance estimation technology has evolved in various fields. In such distance estimation, normal distance estimation using a monocular optical system (single optical system) is a simple distance measurement means because a distance image can be acquired from one image, but since the distance estimation is not physical distance measurement, the depth is estimated even in a plane image. In addition, in the distance estimation using a compound-eye optical system, in general, the distance estimation can be performed with high accuracy by imaging using two cameras and using a parallax of each image, but it is necessary to accurately calibrate a relationship between positions or imaging directions of the two cameras, and the distance estimation is not a simple distance measurement means. In addition, in the distance estimation using a plurality of images captured by moving the monocular optical system, in addition to the necessity of accurately calibrating the relationship between the positions or the imaging directions of the cameras as in the case of the compound-eye optical system, it is not possible to simultaneously capture necessary images, and thus there is a situation in which the distance estimation is difficult, such as a case where a subject is moving.

In view of such circumstances, the present inventor has conducted intensive studies and has obtained the findings that “by using a phase difference image acquired by a monocular optical system, it is possible to perform distance estimation using parallax (phase difference) like a compound-eye optical system by pupil division while using the monocular optical system, and it is possible to perform simple and highly accurate distance measurement” and that “a phase difference map can be generated from the phase difference image in the process of the distance estimation and can be used for control of an imaging apparatus or the like”. The present invention has been created based on such findings, and hereinafter, specific aspects of a phase difference map generation apparatus, a phase difference map generation method, an image data acquisition apparatus, a focusing control method, a learning method, and a phase difference map generator according to the present invention will be described.

### First Embodiment

### Overall Configuration of Imaging Apparatus

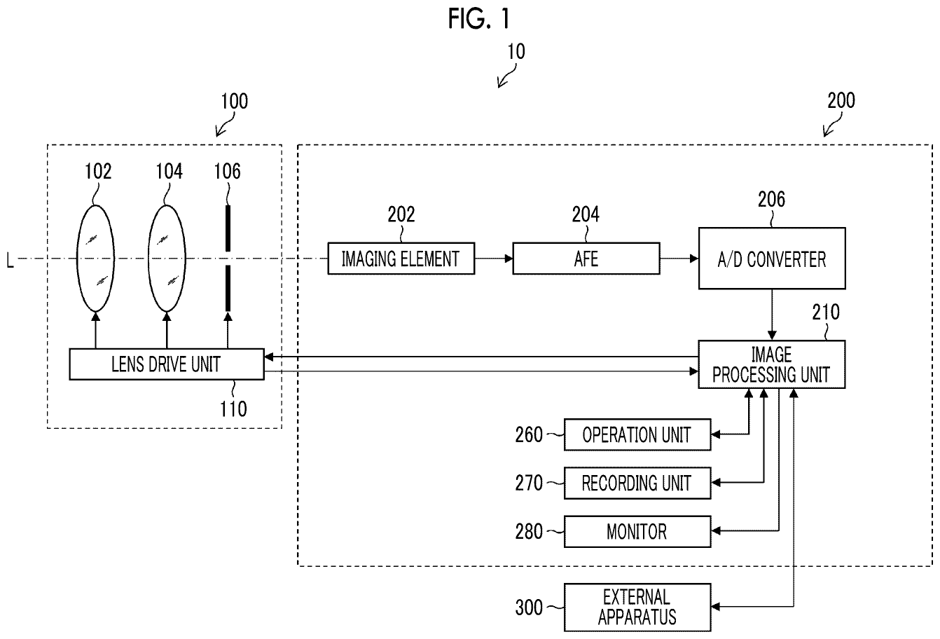

FIG. 1 is a diagram showing a configuration of an imaging apparatus 10 (imaging apparatus, image data acquisition apparatus) according to a first embodiment. The imaging apparatus 10 is composed of an interchangeable lens 100 (single optical system, monocular optical system, image data acquisition unit) and an imaging apparatus body 200 (image data acquisition unit), and forms a subject image (optical image) on an imaging element 202 by an imaging lens including a zoom lens 102 described later. The interchangeable lens 100 and the imaging apparatus body 200 can be attached and detached through a mount (not shown).

### Configuration of Interchangeable Lens

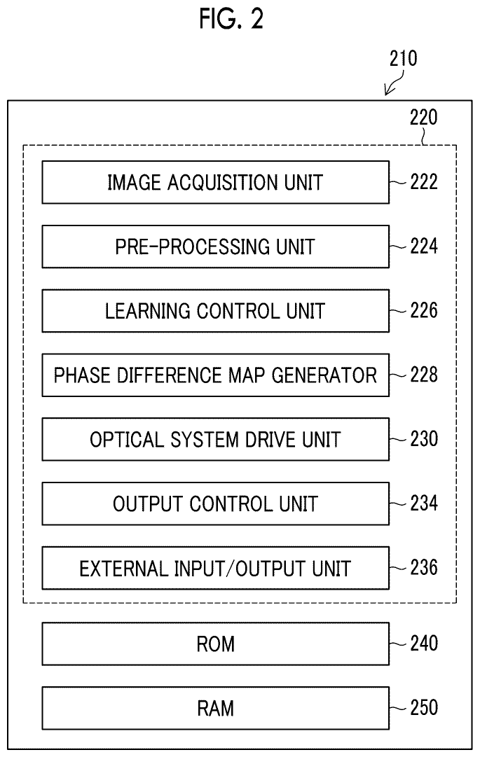

The interchangeable lens 100 comprises the zoom lens 102, a focus lens 104, a stop 106, and a lens drive unit 110. The lens drive unit 110 drives the zoom lens 102 and the focus lens 104 forward and backward in response to a command from an image processing unit 210 (optical system drive unit 230 in FIG. 2) to perform zoom (optical zoom) adjustment and focus adjustment. The zoom adjustment and the focus adjustment may be performed according to a zoom operation and a focus operation (rotation of a zoom ring and a focus ring (not shown) or the like) performed by a user, in addition to the command from the image processing unit 210. In addition, the lens drive unit 110 controls the stop 106 in response to a command from the image processing unit 210 to adjust exposure. On the other hand, information such as positions of the zoom lens 102 and the focus lens 104 and an opening degree of the stop 106 is input to the image processing unit 210. The interchangeable lens 100 has an optical axis L.

### Configuration of Imaging Apparatus Body

The imaging apparatus body 200 comprises an imaging element 202 (imaging element), an analog front end (AFE) 204, an analog to digital (A/D) converter 206 (imaging unit), an image processing unit 210, an operation unit 260, a recording unit 270, and a monitor 280. The imaging apparatus body 200 may have a shutter (not shown) for shielding light incident on the imaging element 202. In a case where the imaging apparatus body 200 comprises the shutter, it is preferable that a shutter speed is variable.

The imaging element 202 comprises a light-receiving surface on which a large number of light-receiving elements are arranged in a two-dimensional matrix. A color pixel and a phase difference pixel are provided on the light-receiving surface of the imaging element 202, and a color image and a phase difference image (phase difference image data) of a subject can be acquired. Then, subject light transmitted through the zoom lens 102, the focus lens 104, and the stop 106 is formed into an image on the light-receiving surface of the imaging element 202, and is converted into an electrical signal by each light-receiving element. A detailed configuration of the imaging element 202 and acquisition of image data will be described below. Various photoelectric conversion elements such as a complementary metal-oxide semiconductor (CMOS) and a charge-coupled device (CCD) may be used as the imaging element 202.

The AFE 204 performs noise removal, amplification, and the like of an analog image signal output from the imaging element 202. The A/D converter 206 converts the captured analog image signal into a digital image signal with a gradation width.

### Configuration of Image Processing Unit

FIG. 2 is a diagram showing a configuration of an image processing unit 210. The image processing unit 210 comprises a processor 220 (processor), a read only memory (ROM) 240, and a random access memory (RAM) 250. The processor 220 includes an image acquisition unit 222, a pre-processing unit 224, a learning control unit 226, a phase difference map generator 228, an optical system drive unit 230, an output control unit 234, and an external input/output unit 236. The processing by these functions will be described in detail below.

For example, the processor 220 is configured by various processors or electric circuits such as a central processing unit (CPU), a graphics processing unit (GPU), a field programmable gate array (FPGA), and a programmable logic device (PLD). In a case where these processors and electric circuits execute software (program), codes readable by a computer (for example, various processors and electric circuits constituting the processor and/or combinations thereof) of the software to be executed are stored in a non-transitory and tangible recording medium, such as the ROM 240, and the computer refers to the software.

The software stored in the non-transitory and tangible recording medium includes various programs according to the embodiment of the present invention (programs causing a computer to execute the phase difference map generation method, the focusing control method, and the learning method according to the embodiment of the present invention) and data used in executing the programs. The code may be recorded on a non-transitory and tangible recording medium such as a flash ROM or an electronically erasable and programmable read only memory (EEPROM) instead of the ROM 240. The “non-transitory and tangible recording medium” does not include intangible recording media such as carrier-wave signals or propagated signals themselves. In a case of processing using software, the RAM 250 is used as a temporary storage area or a work area.

### Configuration of Operation Unit and Monitor

The operation unit 260 includes a release button, an operation button, a dial, a switch, and the like (not shown), and the user can perform various operations such as acquisition of a color image and a phase difference image (phase difference image data), learning of a phase difference map generator, generation of a phase difference map or a distance image, and output of these results. The monitor 280 may be configured by a touch panel type device, and the device may be used as the operation unit 260. In addition, the operation unit 260 may include a microphone or a speaker (not shown).

The monitor 280 (display device) is configured by a touch panel type liquid crystal display panel, and can display a normal moving image or still image, phase difference image data, correction image data, a phase difference map, distance image data, and the like. The monitor 280 can be disposed on a rear surface side, a top surface side, or the like of the imaging apparatus body 200.

### Configuration of Recording Unit

The recording unit 270 (recording unit) is configured by a non-transitory and tangible recording medium such as various magneto-optical recording media and a semiconductor memory, and a control circuit thereof, and records phase difference image data, correction image data, a phase difference map, distance image data, and the like. Data acquired from the external apparatus 300 may be recorded in the recording unit 270. The data recorded in the recording unit 270 can be displayed on the monitor 280 or output to the external apparatus 300 automatically in response to an instruction from the user via the operation unit 260 or without the instruction from the user. The recording medium used in the recording unit 270 may be a type that can be attached to and detached from the imaging apparatus body 200, such as various memory cards.

### External Apparatus

The external apparatus 300 can be connected to the imaging apparatus 10 to perform input and output of information. The connection may be performed by wired communication or short-range wireless communication, or may be performed via a network. Various display devices or recording devices can be used as the external apparatus 300, and an imaging apparatus other than the imaging apparatus 10 may be used as the external apparatus 300. In addition, a vehicle, a moving body, or the like may be used as the external apparatus 300, and data (a normal moving image, a still image, a phase difference map, or distance image data) output from the imaging apparatus 10 may be used for controlling devices of the vehicle, the moving body, or the like (for example, focusing control, maintaining an inter-vehicle distance, trajectory control, collision avoidance, or hazard avoidance).

### Configuration of Imaging Element

### Example of Pixel Arrangement (Part 1)

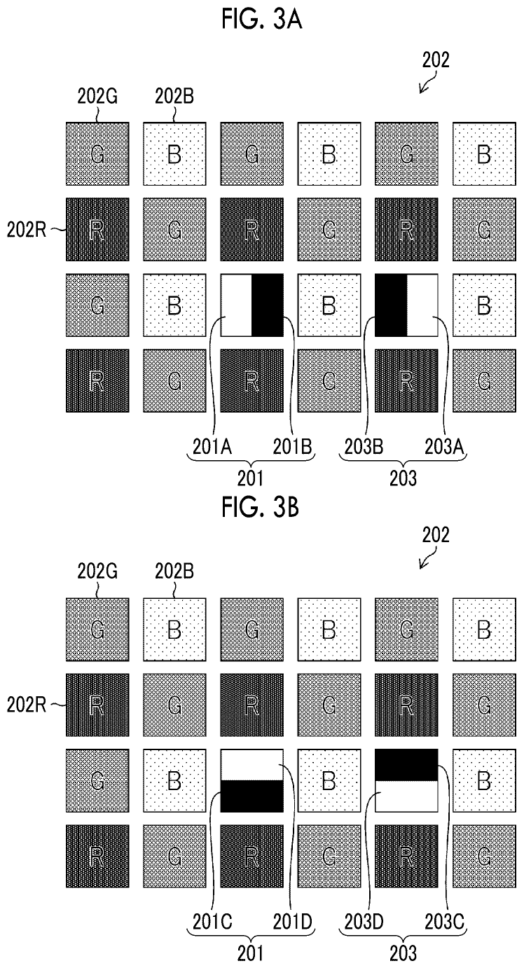

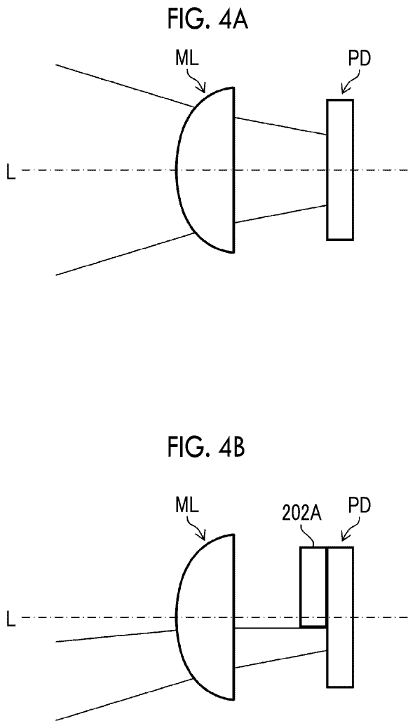

FIGS. 3A and 3B are diagrams showing an example of a pixel arrangement in the imaging element 202 (a state in which a light-receiving surface of the imaging element 202 is viewed from a subject side), and FIGS. 4A and 4B are diagrams showing a configuration example of each pixel. As shown in FIGS. 3A and 3B, the imaging element 202 comprises phase difference pixels and color pixels. In the example of FIGS. 3A and 3B, the imaging element 202 comprises color pixels 202R, 202G, and 202B (color pixels), and color filters (optical filters) that transmit red light, green light, and blue light are disposed in the color pixels, respectively. The color filters constitute “a plurality of optical filters that transmit light having wavelength ranges that are at least partially different”. In FIGS. 3A and 3B, the pixel arrangement is a Bayer array, but other arrangements such as a diagonal Bayer array (double Bayer array), X-Trans (registered trademark), and a Quad Bayer array may be used. The image processing unit 210 (processor 220) can generate a color image (RGB image) by using signals output from the color pixels.

In the following description, the color pixels 202R, 202G, and 202B may be referred to as an “R pixel”, a “G pixel”, and a “B pixel”, respectively. In addition, a microlens is provided in the color pixel and the phase difference pixel (not shown in FIGS. 3A and 3B, see FIGS. 4A and 4B).

### Arrangement (Intermittent Arrangement) of Phase Difference Pixels

As shown in FIG. 3A, the imaging element 202 comprises phase difference pixels 201 and 203 (phase difference pixels). The phase difference pixel 201 has an opening 201A provided on a right side (left side in the drawing) of the pixel to function as a light receiving section, and a left side (right side in the drawing; one side of the light receiving section) of the pixel is shielded from light by a mask 201B. On the other hand, the phase difference pixel 203 has an opening 203A provided on a left side (right side in the drawing) of the pixel to function as a light receiving section, and a right side (left side in the drawing; the other side of the light receiving section) of the pixel is shielded from light by a mask 203B. The image acquisition unit 222 (processor) can acquire image data generated from a signal output from the phase difference pixel 201 as first phase difference image data, and can acquire image data generated from a signal output from the phase difference pixel 203 as second phase difference image data.

FIG. 3A is an example of a case where one pixel is divided and shielded from light in the left-right direction, but as shown in FIG. 3B, the pixel may be divided and shielded from light in the up-down direction. In the example shown in FIG. 3B, the phase difference pixel 201 has an opening 201D provided on an upper side (upper side in the drawing) of the pixel to function as a light receiving section, and a lower side (lower side in the drawing; one side of the light receiving section) of the pixel is shielded from light by a mask 201C. On the other hand, the phase difference pixel 203 has an opening 203D provided on a lower side (lower side in the drawing) of the pixel to function as a light receiving section, and an upper side (upper side in the drawing; the other side of the light receiving section) of the pixel is shielded from light by a mask 203C. In this case, the image acquisition unit 222 (processor) can acquire image data generated from a signal output from the phase difference pixel 201 as first phase difference image data, and can acquire image data generated from a signal output from the phase difference pixel 203 as second phase difference image data.

In the example of FIGS. 3A and 3B, the phase difference pixels are disposed at positions of the G pixels, but the phase difference pixels may be disposed at positions of the R pixels or the B pixels. In addition, in the example of FIGS. 3A and 3B, the color filters are not disposed in the phase difference pixels, but the color filters may be disposed in the phase difference pixels.

FIGS. 4A and 4B are diagrams showing configurations of the color pixel and the phase difference pixel. As shown in FIG. 4A, the color pixel comprises a microlens ML and a photodiode PD (the color filter is not shown). As shown in FIG. 4B, one phase difference pixel comprises the microlens ML, the photodiode PD, and a mask 202A. As described above with reference to FIGS. 3A and 3B, the position of the mask 202A can be on the left and right or on the upper and lower sides. The position, the shape, and the size of the mask 202A can be set according to the position, the shape, and the size of the directed pupil.

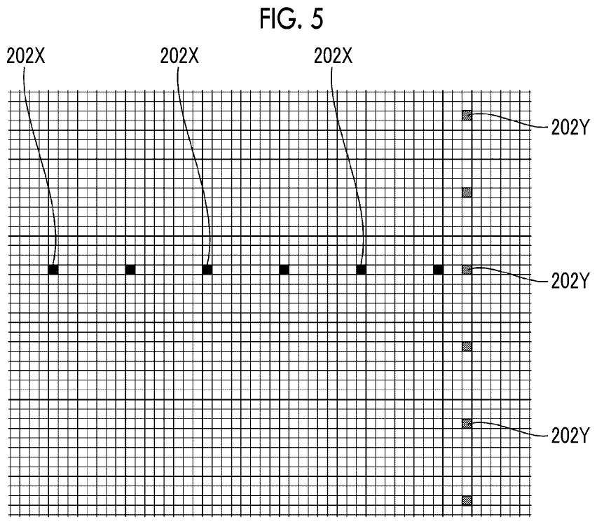

FIG. 5 is a diagram showing an example in which the phase difference pixels are two-dimensionally arranged. In the example shown in FIG. 5, phase difference pixels 202X divided into left and right sides as shown in FIG. 3A and phase difference pixels 202Y divided into upper and lower sides as shown in FIG. 3B are arranged in a direction orthogonal to each other, and the phase difference pixels are two-dimensionally arranged as a whole. In FIG. 5, the phase difference pixels 202X and the phase difference pixels 202Y are shown in one row each, but in order to generate a phase difference map with high accuracy, it is preferable to arrange the phase difference pixels in the vertical direction and the horizontal direction over the entire surface of the imaging element 202. In a case where it is not necessary to acquire the color image, all the pixels of the imaging element 202 may be the phase difference pixels.

For a pixel position where the color pixel cannot be disposed because the phase difference pixel is disposed, the signal at the position can be obtained by an interpolation calculation using the signal in the peripheral pixel.

### Phase Difference Pixel (Entire Surface Disposition)

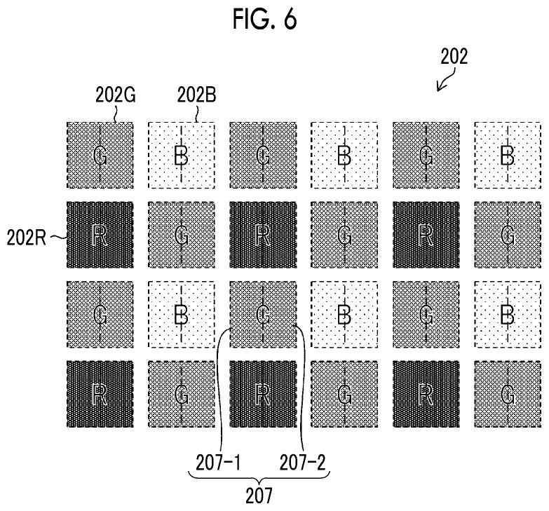

FIG. 6 is a diagram showing an example in which all the pixels of the imaging element 202 are the phase difference pixels. In the example of FIG. 6, the phase difference pixel 207 is formed by dividing the light receiving section (the photodiode PD in FIGS. 4A and 4B) in the left-right direction into a phase difference pixel 207-1 and a phase difference pixel 207-2. By individually extracting the signals of the phase difference pixel 207-1 and the phase difference pixel 207-2, the phase difference image (phase difference image data) can be generated in the same manner as in a case where the light is shielded by the mask. In addition, in a case where it is not necessary to acquire the phase difference image, the normal image can be generated by adding the signals of the phase difference pixel 207-1 and the phase difference pixel 207-2. In addition, since the color filters are disposed in the phase difference pixel 207-1 and the phase difference pixel 207-2, the color image can be generated even in a case where the pixel is divided and used as the phase difference pixel and even in a case where the pixel is used as one pixel. Although FIG. 6 shows an example in a case where the phase difference pixel is divided in the left-right direction, the phase difference pixel may be divided in the up-down direction as described above for FIGS. 3A and 3B. By two-dimensionally arranging the pixel divided in the left-right direction and the pixel divided in the up-down direction, a high-accuracy phase difference map can be generated.

### Relationship Between Phase Difference Amount and Focus Deviation

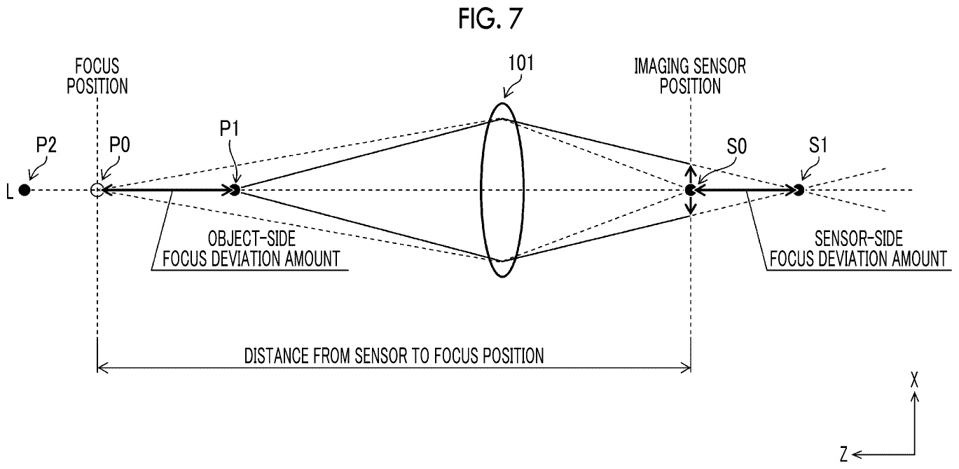

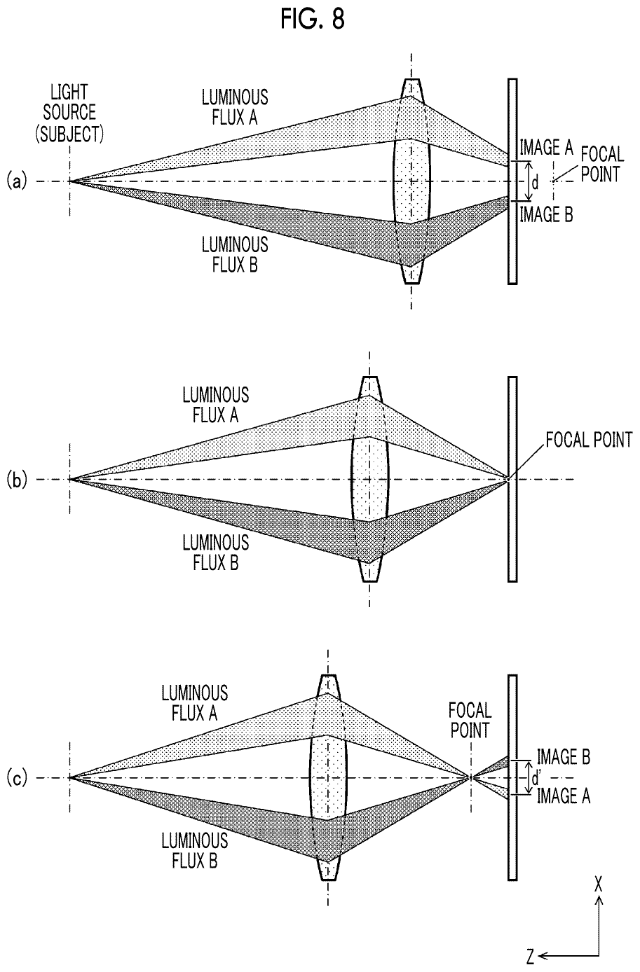

FIG. 7 is a conceptual diagram showing a relationship between the phase difference amount and the focus deviation. FIG. 7 is a diagram showing a state in which the optical system of the interchangeable lens 100 is viewed in a direction orthogonal to the optical axis L, and the lens 101 is a virtual representation of a lens included in the optical system. In this state, in a case where it is assumed that light from a subject (point light source) present at a point P0 is imaged at a point S0 (a position where the imaging surface of the imaging sensor is present), light from a subject present at a point P1 on the −Z side with respect to the point P0 is imaged at a point S1 on the −Z side with respect to the point S0. In this case, a luminous flux (displayed by a solid line in the drawing) from the point P1 has a spread (displacement) in the ±X direction on the imaging surface. An amount of the deviation in the ±X direction corresponds to the phase difference amount, and a direction of the deviation corresponds to a direction of the phase shift. In the present invention, as will be described in detail later, the phase difference amount and the direction of the phase shift are mapped as a phase difference map. Light from a subject present at a point P2 on the +Z side with respect to the point P0 is imaged on the +Z side with respect to the point S0, and a direction of the phase shift is opposite to a direction of the phase shift of the subject present at the point P1 (see the description related to FIG. 8).

The focus deviation (amount of deviation and direction of the deviation) in the ±Z direction corresponds to the distance information, and can be mapped as distance image data as will be described in the second embodiment.

### Focusing Control Based on Phase Difference Image

FIG. 8 is a diagram showing a state of focusing control (focusing) based on the phase difference image (the light blocking mask is not shown). Portions (a) to (c) of FIG. 8 show a so-called “rear pin (rear focus)” state (a state where a focal point is present after a light-receiving surface), a “just pin (in focus)” state (a state where the focal point is focused on a target position and is present on the light-receiving surface), and a “front pin (front focus)” state (a state where the focal point is present in front of the light-receiving surface), respectively. “Just” in “just pin” is an abbreviation for “just”, and “pin” is an abbreviation for “pinto (focus)”. The “just pin” can be expressed as “just-focused” or “in perfect focus” in English. As shown in FIG. 8, in a case of the “rear pin (rear focus)” and a case of the “front pin (front focus)”, directions of the deviation (directions of the phase shift) between a luminous flux A transmitted through the +X side of the lens and a luminous flux B transmitted through the-X side of the lens are opposite to each other. The phase difference amounts in the case of the “rear pin (rear focus)” and the case of the “front pin (front focus)” are “displacement d” and “displacement d′”, respectively.

In the imaging apparatus 10 according to the first embodiment, the drive direction of the focus lens 104 is determined based on the direction of the phase shift described above with reference to FIGS. 7 and 8, and the focus lens 104 is driven such that the amount of the phase shift is zero, so that the target subject can be focused.

### Influence of Focus Deviation in Color Image and Phase Difference Image

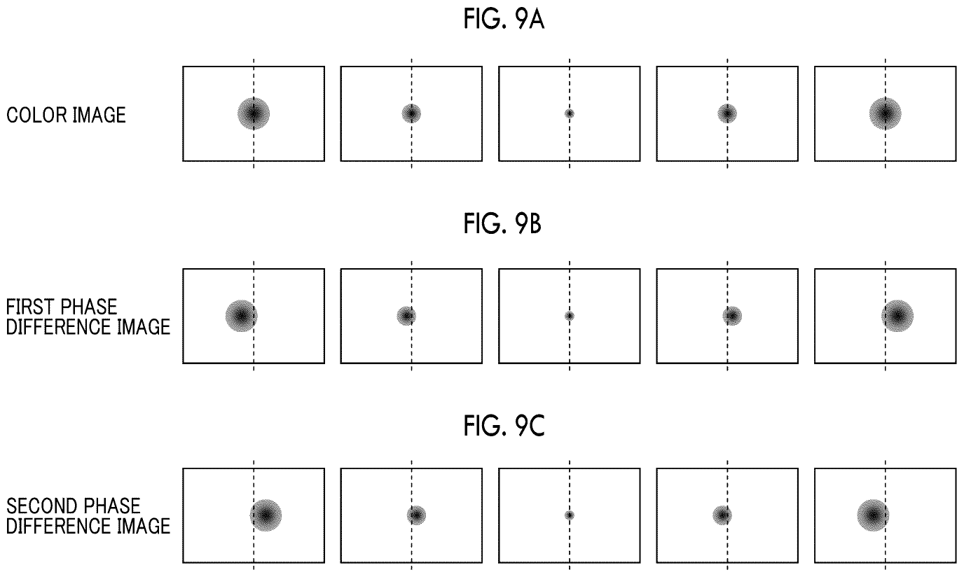

FIGS. 9A to 9C are diagrams showing an influence of the focus deviation on the color image and the phase difference image. The subject is a point light source present at the center of the angle of view. FIGS. 9A to 9C show a color image, a phase difference image 1 (for example, a left viewpoint image), and a phase difference image 2 (for example, a right viewpoint image), respectively. In FIGS. 9A to 9C, the image on the right side of the figure is the “rear pin (rear focus)” described above, the image on the left side of the figure is the “front pin (front focus)”, and the image at the center of the figure is the “just pin (in focus)”. As the in-focus state deviates from the “just pin (in focus)”, the blurriness of the subject image increases. In addition, as described above with reference to FIGS. 7 and 8, in the phase difference image, the directions of the deviation in the phase difference images 1 and 2 are opposite to each other, and the directions of the deviation are also opposite to each other between the “front pin (front focus)” and the “rear pin (rear focus)”. In the “just pin (in focus)”, the blurriness of the subject image in the phase difference image is zero, and the two subject images overlap each other.

### Generation of Phase Difference Map by Phase Difference Map Generator

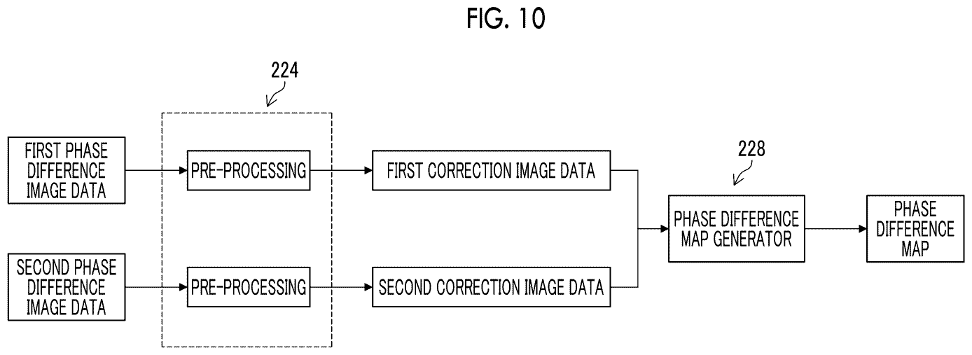

FIG. 10 is a diagram conceptually showing a state of the phase difference map generation. The image acquisition unit 222 (processor) acquires the phase difference images 1and 2 (first phase difference image data and second phase difference image data) via the interchangeable lens 100, the imaging element 202, and the like, and the pre-processing unit 224 (processor) performs the pre-processing on the first phase difference image data and the second phase difference image data to acquire the first correction image data and the second correction image data. The phase difference map generator 228 (processor) generates a phase difference map in which the phase difference amount and the direction of the phase shift between the first phase difference image data and the second phase difference image data are mapped from the first correction image data and the second correction image data obtained by the pre-processing.

### Pre-Processing

As described above, according to the embodiment of the present invention, it is possible to generate the phase difference map and to perform the distance measurement with high accuracy in a simple manner by using the monocular phase difference optical system. However, the phase difference image is affected by the characteristics of the optical system or the imaging sensor (imaging element) used for the imaging, and it is difficult to directly estimate the distance from the parallax image. By performing the learning including the characteristics of the optical system and the imaging sensor, it is possible to perform the distance estimation. However, in a situation in which a large number of lenses are assumed to be mounted, such as a lens-interchangeable digital camera, and the optical system and the imaging conditions change in a wide range, it is also considered that the conditions during the learning and the actual conditions are different, and it is difficult to perform the high-accuracy distance measurement in such a case. Therefore, by performing the pre-processing according to the characteristics of the optical system and the characteristics of the imaging sensor during the imaging, it is possible to perform the distance estimation with high accuracy even in any optical system or imaging condition.

The “pre-processing” described above is the processing based on the characteristics of the processing of generating the phase difference map, and as will be described below, it is possible to perform the processing of absorbing the difference between the acquisition conditions of the phase difference image data for learning and the acquisition conditions of the actual phase difference image data or the processing of reducing the difference between the image quality of the first phase difference image data and the image quality of the second phase difference image data. It is preferable to perform at least one of these pieces of processing.

### Example of Pre-Processing

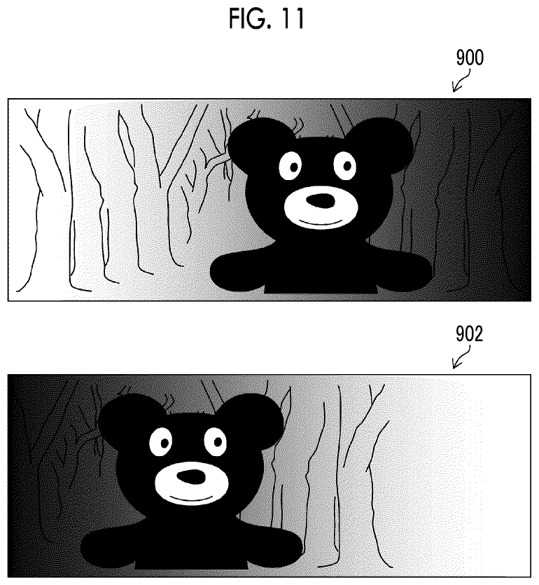

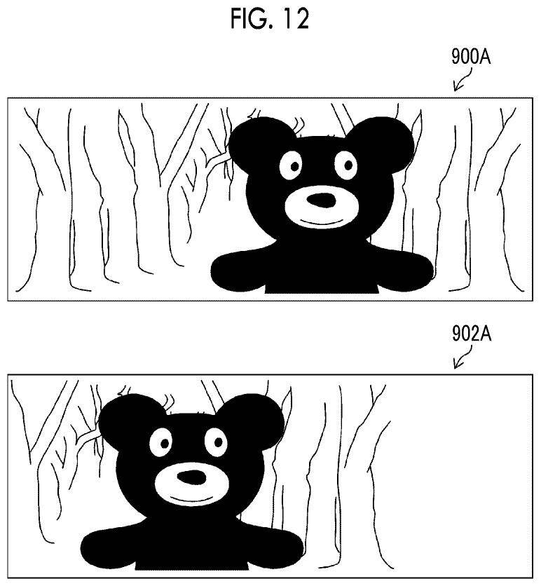

FIGS. 11 and 12 are conceptual diagrams for describing the pre-processing. Specifically, FIG. 11 is phase difference images 900 and 902 (first and second phase difference image data; left phase difference image and right phase difference image) before the pre-processing is performed, and FIG. 12 is phase difference images 900A and 902A (first and second correction image data) in a state in which the pre-processing is performed. As described above, in a case in which the phase difference image data (actual image data used for phase difference map generation) is acquired by the phase difference pixels in which the mask for light shielding is disposed (as described in FIGS. 3A to 4B and the like), the distribution of the brightness is not uniform in the phase difference images 900 and 902 before the pre-processing is performed. Therefore, it is preferable to perform the processing of aligning the brightness of the left and right phase difference images (left and right viewpoint images) (processing for eliminating the unevenness within the angle of view of the image data caused by the light shielding method) as shown in the phase difference images 900A and 902A.

In addition, in a case in which the image for learning is acquired by an optical system other than the monocular phase difference optical system having the above-described configuration (for example, in a case in which a compound-eye optical system is used or in a case in which a plurality of times of imaging is performed by a monocular optical system), the difference in brightness in the phase difference image and the difference in brightness between the phase difference images are small. Therefore, the difference between the image for learning and the image actually used is large. Therefore, it is preferable to align the brightness in the pre-processing and to absorb the influence of the difference between the image during learning and the actual image.

With such pre-processing, it is easy to detect the correspondence points between the images, and the phase difference map and the distance image data based on the phase difference map can be generated with high accuracy.

It is preferable that the pre-processing is performed for at least one of the resolution, the noise, the gradation, or the image structure. Here, the “gradation” may include the brightness and the contrast, and the “image structure” may include the contrast, the sharpness, the distortion, and the shading.

In addition, in the first embodiment, it is preferable that the image acquisition unit 222 and the pre-processing unit 224 (processor) acquire the data acquisition conditions of the first phase difference image data and the second phase difference image data and perform the pre-processing according to the data acquisition conditions. For example, the F number can be acquired as the data acquisition condition, and the size of the phase difference image (first and second correction image data) input to the phase difference map generator 228 can be increased according to the F number. Specifically, in a case in which the F number is large, the left and right rays approach each other, and the phase difference amount is reduced. Therefore, in a case in which the F number is large, the size of the image is increased, and the phase difference on the image (in appearance) is also increased, so that the phase difference can be favorably detected. Since the phase difference amount is largely detected by this processing, it is preferable that the phase difference map generator 228 (processor) reduces the phase difference amount according to the magnification ratio of the image size in a case of generating the final phase difference map.

In addition, in the first embodiment, the pre-processing unit 224 (processor) may perform different pre-processing on the first phase difference image data and the second phase difference image data. Specifically, the pre-processing unit 224 may perform different processing on these phase difference image data in at least one of content or degree. By such pre-processing, the phase difference map can be generated with high accuracy in consideration of the difference in image quality of the phase difference image due to the characteristics of the optical system (various aberrations and the like). The pre-processing unit 224 may determine the content and the degree of the pre-processing in response to the operation of the user via the operation unit 260, or may automatically determine the content and the degree of the pre-processing without depending on the operation of the user.

### Construction of Phase Difference Map Generator by Machine Learning

In the first embodiment, the phase difference map generator 228 is a phase difference map generator constructed by an algorithm of machine learning. Specifically, the phase difference map generator 228 can be constructed by training a neural network by providing the first and second phase difference image data and distance information (ground-truth data) corresponding to these phase difference images as learning data. Such a neural network includes, for example, a convolutional neural network (CNN), a deep neural network (DNN), a recurrent neural network (RNN), and an autoencoder.

### Example of Layer Configuration of CNN

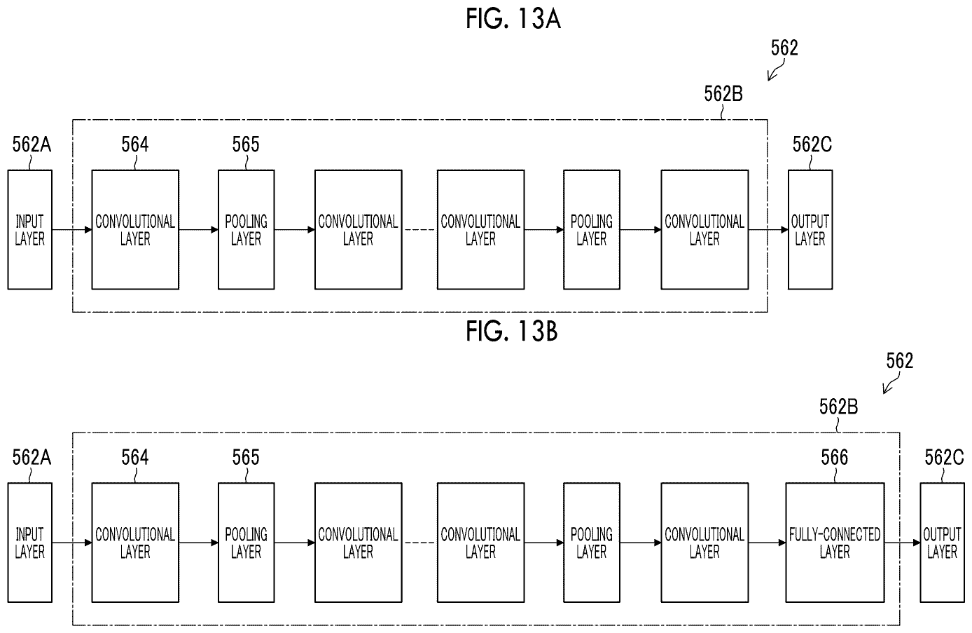

FIGS. 13A to 13B are diagrams showing an example of a layer configuration of a convolutional neural network (CNN). In the example shown in FIG. 13A, a CNN 562 includes an input layer 562A, an intermediate layer 562B, and an output layer 562C. The input layer 562A receives the phase difference image (first correction image data and second correction image data) after the pre-processing and outputs a feature value. The intermediate layer 562B includes a convolutional layer 564 and a pooling layer 565, and the feature value output by the input layer 562A is input to calculate other feature values. These layers have a configuration in which a plurality of “nodes” are connected by “edges” and hold a plurality of weight parameters. The value of the weight parameter changes as the learning progresses. As in the example illustrated in FIG. 13B, the CNN 562 may include a fully-connected layer 566. The layer configuration of the CNN 562 is not limited to a case in which one convolutional layer 564 and one pooling layer 565 are repeated; alternatively, one of the layers (for example, the convolutional layer 564) may be included in a plurality of consecutive layers. In addition, a plurality of fully-connected layers 566 may be continuously included.

### Processing in Intermediate Layer

The intermediate layer 562B calculates the feature value by a convolution operation and a pooling process. The convolution operation performed in the convolutional layer 564 is processing of acquiring a feature map through convolution operations using filters, and plays a role of feature extraction such as edge extraction from the image. By the convolution operation using filters, a “feature map” of one channel (one sheet) is generated for one filter. The size of the “feature map” is downscaled by convolution and becomes smaller as convolution is performed at each layer. The pooling process performed in the pooling layer 565 is a process of reducing (or enlarging) the feature map output by the convolution operation to make a new feature map, and plays a role of imparting robustness so that the extracted features are not affected by translation or the like. The intermediate layer 562B can be configured by one or a plurality of layers performing the processing.

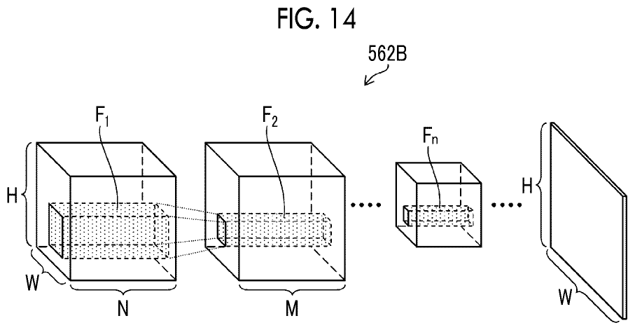

FIG. 14 is a diagram showing a state of the convolution with the filter in the intermediate layer 562B. In the first convolutional layer of the intermediate layer 562B, a convolution operation is performed between the image set (the learning image set in a case of learning, and the measurement image set in a case of distance measurement) composed of a plurality of phase difference images and the filter F₁. The image set is composed of, for example, an image having an image size of H in the vertical direction and W in the horizontal direction. In a case of such an image, for example, a two-dimensional filter of (3×3) can be used as the filter F₁ to be convolved with the image set. In addition, in a case of an image of which the vertical direction is H, the horizontal direction is W, and the depth is D, for example, a three-dimensional filter of (3×3×3) can be used. Through the convolution operation using the filter F₁, a “feature map” of one channel (a single plane) is generated for one filter F₁.

The size of the filter does not need to be linked to the number of channels of the image, and the number of channels can be freely determined. In addition, the number of filters can be determined according to the number of channels of the next layer.

In a case where two phase difference images generated by the output of the phase difference pixel in which the color filter is not disposed as shown in FIGS. 3A and 3B are input, the image set is two channels (one channel×two; the first and second phase difference images are paired). In this case, one channel may be input on each of the left and right sides and the channels may be combined in the middle of the network, or two channels may be input by being superimposed from the beginning. In addition, in a case where a color phase difference image based on the output of the phase difference pixel in which the color filter is disposed is input, the image set is composed of 2×3 channels (the first and second phase difference images×3 (red (R), green (G), and blue (B)) images).

As in the first convolutional layer, the convolution operation using the filters F₂ to Fₙ is performed in the second to n-th convolutional layers. The size of the “feature map” in the n-th convolutional layer is smaller than the size of the “feature map” in the second convolutional layer because the size is downscaled by the convolutional layer or the pooling layer up to the previous stage.

In the layers of the intermediate layer 562B, low-order feature extraction (edge extraction or the like) is performed in the convolutional layer close to the input side, and high-order feature extraction (feature extraction related to the shape, structure, and the like of the object; that is, feature point extraction and correspondence point detection) is performed as the layers approach the output side. In a case where segmentation is performed for the purpose of measurement or the like, the convolutional layer in the latter half is upscaled, and in the last convolutional layer, a “feature map” of the same size as the input image set is obtained. On the other hand, in the case of performing object detection, upscaling is not essential because position information is only required to be output.

The intermediate layer 562B may include a layer for batch normalization in addition to the convolutional layer 564 and the pooling layer 565. The batch normalization process is a process of normalizing the distribution of data in units of mini-batch when learning, and plays a role of advancing learning quickly, reducing dependence on initial values, suppressing overfitting, and the like.

### Processing in Output Layer

The output layer 562C is a layer that calculates the phase difference amount and the direction of the phase shift of the correspondence points (feature points corresponding to each other between the phase difference images) in the phase difference image (corrected image) input to the CNN 562 based on the feature map output from the intermediate layer 562B, and outputs the result. A phase difference map can be generated by mapping the phase difference amount and the direction of the phase shift for a large number of correspondence points. In the output layer, for example, the cost feature volume can be constructed by connecting or performing correlation calculation while moving one of the left and right feature maps with respect to the other, the cost feature volume can be converted into the cost volume by three-dimensional convolution operation, and the phase difference map can be generated by soft-argmin operation or the like.

In a case where the CNN 562 having the above-described configuration is used, it is preferable to perform processing (error backpropagation) of calculating a loss (error) by comparing the result output from the output layer 562C with the distance image data (distance information) as the ground-truth data for the image set in the process of learning, and updating the weight parameters in the intermediate layer 562B from the output side layer toward the input side layer such that the loss is reduced.

### Learning Method of Neural Network

In the first embodiment, the learning control unit 226 (processor) can construct the phase difference map generator 228 (phase difference map generator) by training the neural network such as the CNN 562 by providing, as the learning data, the phase difference image (pair of the first and second phase difference images) and the distance information (distance image data) as the ground-truth data. That is, the phase difference map generator 228 is a trained model constructed by the learning method according to the embodiment of the present invention.

It is also possible to construct the trained model by a device other than the imaging apparatus 10 and transplant the constructed model (including the value of the weight parameter and the like) to be used as the phase difference map generator 228. In a case where such a trained model is used, the processor 220 need not include the learning control unit 226.

### Identity of Image Data Acquisition Condition

In a case where the phase difference image data for learning is acquired, it is preferable that the acquisition conditions are aligned between the first and second phase difference image data. Specifically, it is preferable that the first and second phase difference images are acquired in a state where at least one data acquisition condition is the same, and the phase difference map generator 228 is constructed by learning using the phase difference image data. The “data acquisition condition” corresponds to the imaging condition in the normal imaging, and specifically, it is preferable that at least one of the focal length of the optical system, the F number of the optical system, the shutter speed, or the focusing distance is the same. The imaging apparatus 10 according to the first embodiment can acquire the phase difference image by the single optical system and the imaging element including the phase difference pixel, and thus it is easy to align the data acquisition conditions between the phase difference images.

In the generation of the phase difference map and the distance information, in a case where there is a difference in the data acquisition conditions in a case where the first and second phase difference image data are acquired, or in a case where there is a difference between the “data acquisition condition in a case where the image data for learning is acquired” and the “data acquisition condition in a case where the image data used for the actual measurement is acquired”, the influence of the difference can be absorbed by the above-described pre-processing. In a case where there is a difference in brightness between the left and right phase difference images, the learning may be performed in a state where the difference is present, or the learning may be performed after performing the pre-processing to eliminate the difference in brightness by changing the state of FIG. 11 to the state of FIG. 12.

In addition, in the present invention, the phase difference image for learning may be acquired by a device other than the “device including the single optical system and the phase difference pixel” (for example, the imaging apparatus including the compound-eye optical system or the plurality of imaging apparatuses). In this case, it is preferable to absorb the influence of the calibration error of the imaging apparatus or the difference in the optical characteristics by the pre-processing. In addition, it is not always necessary to perform the learning using the phase difference image, and the normal image may be used as long as the difference between the left and right viewpoint images can be learned.

### Data Acquisition Condition of Phase Difference Image Data for Learning

In a case where the phase difference image data for learning is acquired, the same subject is imaged while changing the imaging distance under a determined data acquisition condition (imaging condition). The focus position (focusing distance) can be fixed. The number of data acquisition conditions (the number of “determined data acquisition conditions”) of the phase difference image data used for the learning may be one set or a plurality of sets, and it is possible to generate the high-accuracy phase difference map or the distance image data by performing the learning using a large number of image data acquired under a plurality of sets of conditions (for example, conditions in which the focal length, the stop, the focusing distance, and the like are different). In addition, in the present invention, the phase difference map generation apparatus may include “a plurality of phase difference map generators in which the data acquisition conditions assumed during the learning are different”, and the processor may switch between the plurality of phase difference map generators according to the data acquisition condition in a case where the phase difference image data is actually acquired. However, in a case where the number of sets of data acquisition conditions is large, the learning cost (time required for preparing the data for learning and performing the learning) is increased. Therefore, it is preferable to determine the number of data acquisition conditions in consideration of both the accuracy required for the phase difference map or the distance image data and the allowable learning cost.

In the present invention, since the influence of the difference between the data acquisition condition during the learning and the data acquisition condition during the actual measurement is absorbed by the pre-processing, it is possible to perform the high-accuracy measurement even in a case where the number of sets of data acquisition conditions is one or a small number.

### Acquisition of Distance Information as Ground-Truth Data

In the data for learning, the distance information (distance image data; corresponding to the distance from the imaging apparatus to the subject), as the ground-truth data, may use results obtained by actual measurement using light detection and ranging (LiDAR) (or laser imaging detection and ranging) or the like. The LiDAR is a technique of measuring the distance to the object or the shape of the object from a result of irradiating the object with the laser light and receiving the reflected light, and may be a time of flight (TOF) method using pulsed laser light or a frequency-modulated continuous wave (FMCW) method using continuous wave laser light.

In the imaging apparatus 10 according to the first embodiment, the phase difference map can be generated by the above-described method.

### Construction of Phase Difference Map Generator Using Multiple Phase Difference Images

In the first embodiment, an aspect in which the neural network is mainly trained by inputting two phase difference images and the phase difference map is generated from the two phase difference images will be described. However, in the present invention, the phase difference map generator is not limited to the aspect in which the two phase difference images are used, and three or more phase difference images may be used. For example, as described above with reference to FIGS. 3A and 3B, four phase difference images are generated from the outputs of the phase difference pixels divided in the left-right direction and the up-down direction, and the four phase difference images are input to the neural network to train the neural network, so that the “phase difference map generator that generates the phase difference map from the four phase difference images” can be constructed. In this case (in a case where the four phase difference images are used), the image set has four channels (in a case where the color filter is not disposed in the phase difference pixel).

### Generation and Output of Phase Difference Map

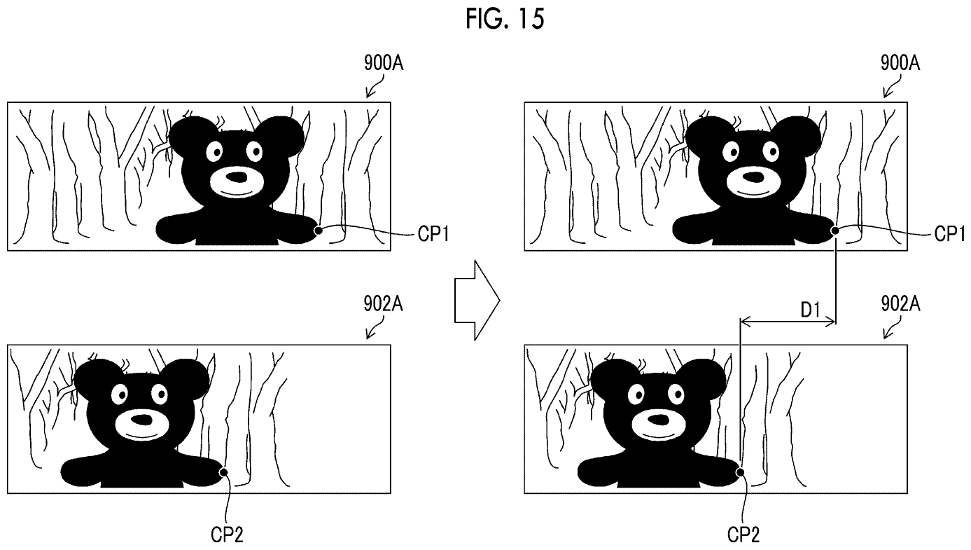

FIG. 15 is a diagram showing an aspect in which the phase difference is calculated from the phase difference image after the pre-processing. In the example of FIG. 15, correspondence point CP1 (first feature point, correspondence point) and correspondence point CP2 (second feature point, correspondence point) are detected in the phase difference images 900A and 902A (first and second correction image data; the same as the example of FIG. 12) after the pre-processing. The correspondence points are feature points of the subject in FIG. 15 and are correspondence points between the phase difference image 900A and the phase difference image 902A, and indicate the same position of the same object in the real space. The phase difference map generator 228 (processor) generates the phase difference map by mapping and outputting the phase difference amount (corresponding to the distance D1 in the example of FIG. 15) and the direction of the phase shift (left-right direction in FIG. 15) for a large number of correspondence points (including the correspondence points CP1 and CP2).

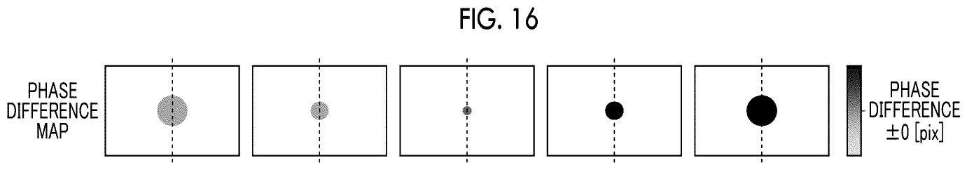

FIG. 16 is a diagram showing an example of a phase difference map (map in a direction perpendicular to the optical axis) for a single subject (point light source). The leftmost diagram corresponds to a “front pin (front focus)” state, the central diagram corresponds to a “just pin (in focus)” state, and the rightmost diagram corresponds to a “rear pin (rear focus)” state. In these diagrams, the size of the spread (blurriness) of the subject image indicates the phase difference amount, and the shading of the subject image indicates the direction of the phase difference (the lighter the color, the more it corresponds to the “front pin (front focus)” state, and the darker the color, the more it corresponds to the “rear pin (rear focus)” state). Since the real subject can be considered as a collection of a plurality of point light sources having different distances, brightness, and the like, the actual phase difference map is in a state in which a plurality of maps as shown in FIG. 16 are superimposed.

Although FIG. 16 shows an example in which the phase difference map is displayed in two dimensions, the processor 220 can display the phase difference map in three dimensions. For example, in a case where the phase difference is negative (in FIG. 16, a state in which the blurriness is close to white), the phase difference map is displayed at a point below the horizontal plane, and in a case where the phase difference is positive (in FIG. 16, a state in which the blurriness is close to a dark color), the phase difference map is displayed at a point above the horizontal plane, so that a three-dimensional surface can be formed for the subject field as a whole. The processor 220A may perform the two-dimensional display and the three-dimensional display of the phase difference map at the same time or may perform the two-dimensional display and the three-dimensional display of the phase difference map by switching. In addition, in FIG. 16, the direction of the phase difference is indicated by shading (black and white) of a single color, but a plurality of colors (for example, purple on the front side and red on the back side) may be assigned and displayed in the direction of the phase difference.

The generated phase difference map can be recorded, displayed, and output to the outside by the output control unit 234 or the external input/output unit 236 (processor).

### Focusing Control Using Phase Difference Map

The optical system drive unit 230 (processor, drive unit) can perform focusing control of determining the focusing position according to the data acquisition conditions of the first and second phase difference image data using the phase difference map generated by the above-described method and driving the focus lens 104 (single optical system) of the interchangeable lens 100 to the focusing position via the lens drive unit 110 (drive unit). The optical system drive unit 230 may set a focusing region in the phase difference map and determine the focusing position based on the distribution of the phase difference amounts in the focusing region. The position, the number, and the shape of the focusing regions are not particularly limited, and one or a plurality of focusing regions may be provided. In addition, the position and the size of the focusing region may be variable, and a region in which a specific subject (for example, a person or another designated subject) is present may be set as the focusing region.

### Second Embodiment

A second embodiment of the present invention will be described. In the second embodiment, since the configuration and the processing related to the generation of the phase difference map are the same as those in the first embodiment, the same reference numerals are assigned to the same configurations as those in the first embodiment, and the detailed description thereof will be omitted. The second embodiment is different from the first embodiment in that the distance image data is generated from the phase difference map by post-processing.

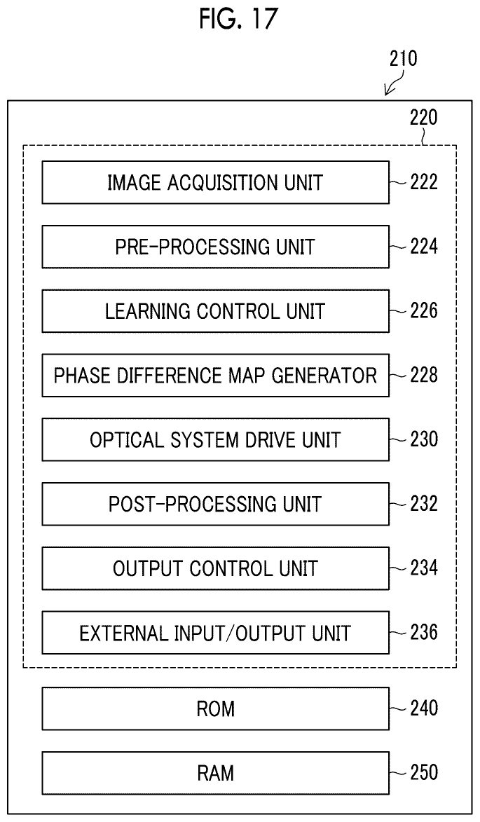

FIG. 17 is a diagram showing a configuration of an image processing unit 210A (processor) in the imaging apparatus according to the second embodiment. The image processing unit 210A is different from the image processing unit 210 according to the first embodiment in that a processor 220A comprises a post-processing unit 232.

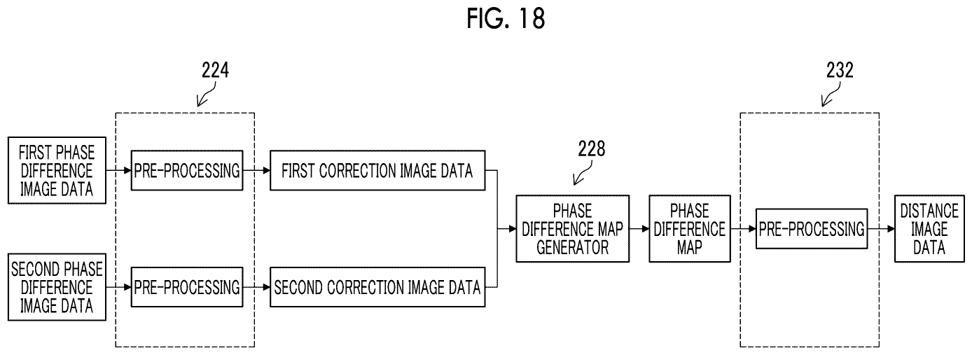

FIG. 18 is a diagram showing a state in which the distance image data is generated from the phase difference map in the second embodiment. The processing up to the phase difference map generation is the same as that in the first embodiment. In the second embodiment, the post-processing unit 232 (processor) converts the phase difference amount of the phase difference map into the distance information in the optical axis direction to generate the distance image data composed of the distance information.

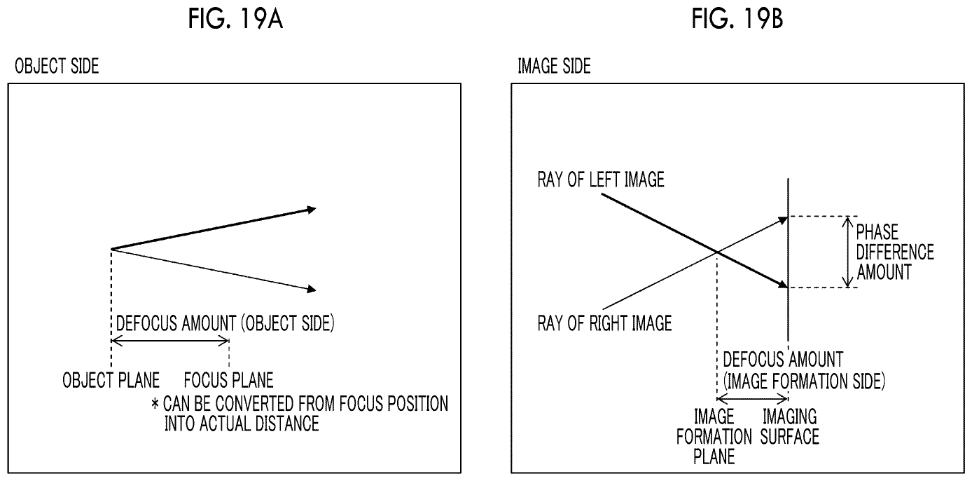

FIGS. 19A to 19B are diagrams showing a state of the post-processing (a state in which the distance information is calculated from the phase difference amount) in the second embodiment. As shown in FIG. 19B, the post-processing unit 232 converts the phase difference amount into the “defocus amount (image formation side)” by using the data acquisition condition such as the ray angle information of the first and second phase difference image data. This defocus amount is the defocus amount as the distance information.

The post-processing unit 232 can perform the post-processing by considering at least one of the ray angle information of the first and second phase difference image data, the position information of the focus lens 104 (focus lens) included in the optical system (in the second embodiment, the interchangeable lens 100) used for acquiring the first and second phase difference image data, or the optical characteristics of the interchangeable lens 100 (optical system) as the data acquisition condition. The post-processing unit 232 may determine which condition to consider for performing the post-processing in response to the instruction of the user via the operation unit 260, or may determine the condition without depending on the instruction of the user. In a case of determining the data acquisition condition to be considered in the post-processing, the post-processing unit 232 may consider the characteristics of the subject.

In a case where the “defocus amount (image formation side)” is X times the focal depth, the defocus amount corresponds to a deviation of X times the depth of field on the object side. The deviation on the object side is the “defocus amount (object side)” in FIG. 19A, and is the defocus amount as the distance information. Since the distance from the current focus position to the focus position is known, the post-processing unit 232 can calculate the distance to the object (the subject distance as the distance information obtained by converting the defocus amount) by adding the above-described “defocus amount (object side)” to the distance. It is preferable that the post-processing unit 232 considers the optical aberration of the interchangeable lens 100 (optical system) in the conversion of the defocus amount on the image formation side and the object side.

The post-processing unit 232 can generate at least one of a “defocus map in which the defocus amount is mapped” or a “distance map in which the subject distance is mapped” as the distance image data. Which one to generate may be determined in response to the instruction of the user via the operation unit 260, or may be determined without depending on the instruction of the user. The output control unit 234 or the external input/output unit 236 (processor) can perform recording, display, external output, or the like on the generated distance image data.

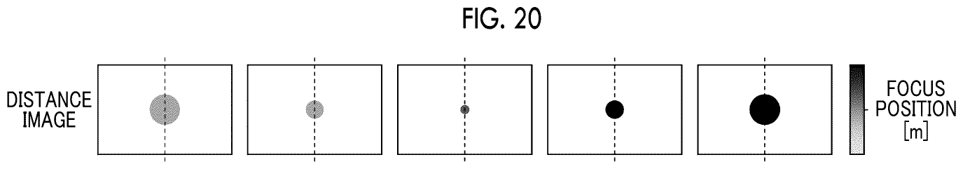

FIG. 20 is a diagram showing an example of the distance image data (map in the optical axis direction) generated by the above-described method (the subject is a point light source). The size of the blurriness corresponds to the distance between the focus position and the object, and the shading of the blurriness corresponds to the deviation from the focus position (the light blurriness is “front pin (front focus)” and the dark blurriness is “rear pin (rear focus)”). The example of FIG. 20 is the “defocus map in which the defocus amount is mapped as one aspect of the distance image data” described above.

FIG. 20 shows an example of a case where the defocus map is displayed in two dimensions. However, as described above for FIG. 16, the processor 220A can display the defocus map and/or the distance map in three dimensions. For example, in a case where the distance is on the front side of the focus position (the side close to the imaging apparatus 10; in FIG. 20, the blurriness is in a state close to white), the display is performed at a point below the horizontal plane, and in a case where the distance is on the back side of the focus position (the side far from the imaging apparatus 10; in FIG. 20, the blurriness is in a state close to dark color), the display is performed at a point above the horizontal plane. In this manner, a three-dimensional surface can be formed for the subject field as a whole. The processor 220A may perform the two-dimensional display and the three-dimensional display of the defocus map and/or the distance map at the same time or may perform the two-dimensional display and the three-dimensional display in a switched manner. In addition, in FIG. 20, the deviation from the focus position is shown by single color shading (black and white), but a plurality of colors (for example, the front side is purple and the back side is red) may be assigned and displayed according to the direction of the deviation.

### Others

In the first and second embodiments described above, the phase difference map is generated by using the machine learning method. However, in the present invention, a method other than the machine learning may be used to generate the phase difference map. For example, the phase difference map can be generated by repeating the correspondence point detection and the phase difference calculation through normal image processing.

While the embodiments of the present invention have been described above, the present invention is not limited to the above-described aspects and can be modified in various manners.

### EXPLANATION OF REFERENCES

10: imaging apparatus
100: interchangeable lens
101: lens
102: zoom lens
104: focus lens
110: lens drive unit
200: imaging apparatus body
201: phase difference pixel
201A: opening
201B: mask
201C: mask
201D: opening
202: imaging element
202A: mask
202B: color pixel
202G: color pixel
202R: color pixel
202X: phase difference pixel
202Y: phase difference pixel
203: phase difference pixel
203A: opening
203B: mask
203C: mask
203D: opening
206: A/D converter
207: phase difference pixel
207-1: phase difference pixel
207-2: phase difference pixel
210: image processing unit
210A: image processing unit
220: processor
220A: processor
222: image acquisition unit
224: pre-processing unit
226: learning control unit
228: phase difference map generator
230: optical system drive unit
232: post-processing unit
234: output control unit
236: external input/output unit
260: operation unit
270: recording unit
280: monitor
300: external apparatus
562A: input layer
562B: intermediate layer
562C: output layer
564: convolutional layer
565: pooling layer
566: fully-connected layer
900: phase difference image
900A: phase difference image
902: phase difference image
902A: phase difference image
d: displacement
d′: displacement
F₁: filter
F₂: filter

What is claimed is:

1. A phase difference map generation apparatus comprising a processor,
wherein the processor is configured to:
acquire, from an image data acquisition unit including a single optical system and an imaging element having a phase difference pixel, at least first phase difference image data and second phase difference image data;
perform pre-processing on the first phase difference image data and the second phase difference image data to acquire first correction image data and second correction image data; and
generate, from the first correction image data and the second correction image data, a phase difference map in which a phase difference amount and a direction of a phase shift between the first phase difference image data and the second phase difference image data are mapped, and
the pre-processing is processing based on characteristics of processing for generating the phase difference map.

2. The phase difference map generation apparatus according to claim 1, wherein the pre-processing is processing for reducing a difference between image quality of the first phase difference image data and image quality of the second phase difference image data.

3. The phase difference map generation apparatus according to claim 1,
wherein the processor is configured to:
acquire image data generated from a signal output by the phase difference pixel in which one side of a light receiving section is shielded, as the first phase difference image data; and
acquire image data generated from a signal output by the phase difference pixel in which the other side of the light receiving section is shielded, as the second phase difference image data.

4. The phase difference map generation apparatus according to claim 1,
wherein, in the pre-processing,
the processor is configured to perform different processing on the first phase difference image data and the second phase difference image data.

5. The phase difference map generation apparatus according to claim 4,
wherein, in the pre-processing,
the processor is configured to perform different processing on the first phase difference image data and the second phase difference image data in at least one of content or degree.

6. The phase difference map generation apparatus according to claim 3, wherein the processor is configured to perform processing for eliminating unevenness within an angle of view of the image data caused by a light shielding method, as the pre-processing.

7. The phase difference map generation apparatus according to claim 1,
wherein the processor is configured to:
acquire data acquisition conditions of the first phase difference image data and the second phase difference image data; and
perform the pre-processing according to the data acquisition conditions.

8. The phase difference map generation apparatus according to claim 7,
wherein, in the pre-processing, the processor is configured to:
enlarge a size of an image indicated by the first phase difference image data and a size of an image indicated by the second phase difference image data according to the data acquisition conditions; and
generate the first correction image data and the second correction image data from the enlarged first phase difference image data and the enlarged second phase difference image data.

9. The phase difference map generation apparatus according to claim 1, wherein the processor is configured to perform the pre-processing for at least one of resolution, noise, gradation, or an image structure.

10. The phase difference map generation apparatus according to claim 1,
wherein the processor is configured to:
extract correspondence points between the first correction image data and the second correction image data, the correspondence points being the same positions of the same objects in a real space; and
generate the phase difference map by mapping a phase difference amount and a direction of a phase shift for the correspondence points.

11. The phase difference map generation apparatus according to claim 1, wherein the processor is configured to generate the phase difference map by using a phase difference map generator constructed by machine learning.

12. The phase difference map generation apparatus according to claim 11, wherein the phase difference map generator is a trained model constructed by training a neural network by providing the first phase difference image data and the second phase difference image data, and distance information corresponding to the first phase difference image data and the second phase difference image data as learning data.

13. The phase difference map generation apparatus according to claim 1, wherein the processor is configured to determine a focusing position according to data acquisition conditions of the first phase difference image data and the second phase difference image data by using the phase difference map.

14. The phase difference map generation apparatus according to claim 13, wherein the processor is configured to determine the focusing position based on a distribution of phase difference amounts in a focusing region set in the phase difference map.

15. The phase difference map generation apparatus according to claim 1, wherein the processor is configured to generate distance image data composed of the distance information by converting the phase difference amount of the phase difference map into the distance information in an optical axis direction.

16. An image data acquisition apparatus comprising:
the phase difference map generation apparatus according to claim 13;
the image data acquisition unit; and
a drive unit that drives the single optical system,
wherein the processor is configured to perform focusing control of driving the single optical system to the focusing position by the drive unit.

17. The image data acquisition apparatus according to claim 16, wherein the imaging element includes a color pixel in which any one of a plurality of optical filters that transmit light having wavelength ranges that are at least partially different is disposed.

18. A focusing control method executed by an image data acquisition apparatus including
a processor,
an image data acquisition unit that includes a single optical system and an imaging element having a phase difference pixel and that acquires first phase difference image data and second phase difference image data of a subject, and
a drive unit that drives the image data acquisition unit,
the focusing control method comprising:
by the processor,
acquiring the first phase difference image data and the second phase difference image data of the subject by the image data acquisition unit;
performing pre-processing on the first phase difference image data and the second phase difference image data to acquire first correction image data and second correction image data;
generating, from the first correction image data and the second correction image data, a phase difference map in which a phase difference amount and a direction of a phase shift between the first phase difference image data and the second phase difference image data are mapped;
determining a focusing position according to data acquisition conditions of the first phase difference image data and the second phase difference image data by using the phase difference map; and
performing focusing control of driving the single optical system to the focusing position by the drive unit, wherein the pre-processing is processing based on characteristics of processing for generating the phase difference map.

19. A learning method comprising:
training a neural network by providing, as learning data, first phase difference image data and second phase difference image data of a subject acquired by an image data acquisition unit including a single optical system and an imaging element having a phase difference pixel, and distance information corresponding to the first phase difference image data and the second phase difference image data; and
constructing, by the training, a phase difference map generator that outputs, in a case where the first phase difference image data and the second phase difference image data are input, a phase difference map in which a phase difference amount and a direction of phase shift between the first phase difference image data and the second phase difference image data are mapped.
